(19) United States
(12) Patent Application Publication
(10) Pub. No.: US 2018/0219697 A1
(43) Pub. Date: Aug. 2, 2018

(54) BUILDING AUTOMATION SYSTEM

(71) Applicant: Savin Automation, Inc., Brookline, MA (US)

(72) Inventor: Michael Propp, Brookline, MA (US)

(21) Appl. No.: 15/887,683

(22) Filed: Feb. 2, 2018

Related U.S. Application Data
(60) Provisional application No. 62/453,908, filed on Feb. 2, 2017.

(51) Int. Cl. H04L 12/28; H04W 4/33; H04W 4/80

(52) U.S. Cl. CPC H04L 12/2816; H04L 12/2832; H04W 4/80; H04W 4/33; H04L 12/2823

(57) ABSTRACT

A method and system for managing automated devices within a multi-dwelling unit. In particular, the present invention relates to a system and method enabling individual tenants to control the automated devices within their respective units and for a building manager or administrator to access and control automated devices for all units within the multi-dwelling units.

### CROSS-REFERENCE TO RELATED APPLICATION(S)

This application claims priority to, and the benefit of, co-pending U.S. Provisional Application No. 62/453,908, filed Feb. 2, 2017, for all subject matter common to both applications. The disclosure of said provisional application is hereby incorporated by reference in its entirety.

### FIELD OF THE INVENTION

The present invention relates to managing automated devices within a multi-dwelling unit. In particular, the present invention relates to a system and method enabling individual tenants to control the automated devices within their respective units and for a building manager or administrator to access and control automated devices for all units within the multi-dwelling units.

### BACKGROUND

Building automation systems (BAS) have been installed in buildings for many years, primarily in larger commercial buildings. Ideally a building automation system would provide control and monitoring of lighting, security (locks and cameras), climate or temperature (e.g., HVAC), and water, although often many systems are focused on just one or two functions, such as security or energy savings. A more recent development is the smart home, where such systems are installed in high-end homes. At present there are not many building automation systems which provide such functionality for multi-dwelling units (MDUs) of two to three units to fifty to one-hundred units. For new construction or significant renovations of a high-end home or larger commercial buildings dedicated wiring can be installed to connect to all the automation devices on the network. For MDUs and for other similar-size buildings being renovated, installing dedicated wiring is often prohibitive. There are now many automation devices, including, for example, locks, thermostats, switches, dimmers, sensors, water shutoff valves, sirens or sounders, that include the capability to communicate over relative low-cost radio frequency (RF) networks for control and monitoring, such as automation networks (e.g., Z-Wave by Sigma Designs). Many of the devices, especially the sensors, are battery-powered, so the devices go to sleep and are activated on a change of state, and then send a message indicating their changed state. It is possible, usually infrequently, that such a message may not be received, for example, if there is significant traffic on the network at the time. Additionally, when the devices are installed in the building, there is an inclusion process to include or add the devices to the network, which often means waking up the battery-operated devices and bringing some devices close to an automation access point (e.g., Z-Wave access points), which can be time intensive. Residents control and monitor the network through an app on a smartphone or tablet. Access to the network by residents should be restricted to only those functions specific to each resident's unit and possibly some functions in common areas. There may also need to be functions that are accessible to only certain building managers based upon levels of management.

### BRIEF DESCRIPTION OF THE FIGURES

These and other characteristics of the present invention will be more fully understood by reference to the following detailed description in conjunction with the attached drawings, in which:

FIG. 1 is an illustrative example of a system for implementing the present invention;

FIG. 2 is a flowchart depicting a process for initializing user accounts for utilizing the system of the present invention;

FIG. 3 is a flowchart depicting a process for monitoring status information for each of the automated devices; and

FIG. 4 is a diagrammatic illustration of a high level architecture for implementing processes in accordance with aspects of the invention.

### SUMMARY

There is a need to provide a building automation system for multi-dwelling units (MDUs) that is easy to set-up, reliable, and includes partitioning of functions to various users. To enable any user to have access to the system from anywhere, the present invention provides a server or servers in the cloud which communicates with the automation controller in the building. The automation controller in the building and the server are programmed so any user who accesses the system (e.g., through an app) only has access to a specific subset of devices so one can restrict access to a specific subset of devices for each user. This partitioning of user access to devices can also allow for overlap so each resident will have access to only the devices in his/her unit and as well as devices in common areas (intended for shared use), while the building manager can have access to the devices in all the units and the common areas, although, possibly, one may want to restrict the building manager from changing functions in the residents' units.

Additionally, rather than being done at the building (as this requires waking up the battery-powered devices and possibly needing to bring them close to the automation access point) setup can be done with all devices in one location, such as at the office of the automation system provider, then labeling the devices and shipping the devices to the building, so they can be installed in the building already programmed with the network information. The automation controller and access points (e.g., Z-wave access points) can be set up and the inclusion process implemented by the access points for each such device can be performed at a central location such that the devices are added to the automation network and configured at the central location.

In accordance with example embodiments of the present invention, a system for managing a plurality of automated devices operating within multi-dwelling units (MDUs) is provided. The system includes a building network infrastructure. The building network infrastructure includes an automation controller in communication with an automation network server and at least one automation access point and a plurality of automated devices each associated with one of a dwelling user account. The individual dwelling users have access to a subset of the plurality of automated devices remotely through an application configured to communicate with the automation controller, the subset of the plurality of automated devices being associated with one or more particular unit MDUs.

In accordance with aspects of the present invention, the automation controller is further configured to periodically send a message on health of all the plurality of automated devices on the building network infrastructure to the automation network server in a cloud. The building network infrastructure can be a radio frequency (RF) network managed by the automation controller and the at least one automation access point. The automation controller can track a status of each of the plurality of smart devices on the building network infrastructure. The system can further include a Power over Ethernet (PoE) switch, wherein the PoE switch enables the plurality of automated devices to be powered by the PoE switch and wherein the plurality of automated devices are reset by sending a command to the PoE switch to power down and then power up one or more of the plurality of automated devices.

In accordance with aspects of the present invention, the automation controller is configured to improve reliability of battery-operated devices of the plurality of automated devices by waking up the battery-operated devices at certain intervals and the automation controller is programmed to poll, through the at least one automation access point, to which of the battery operated devices is included at certain intervals. The individual dwelling users can have remote access to a subset of the plurality of automated devices remotely through a server in communication with the automation controller. The at least one automation access point can include a plurality of access points operating in parallel to establish a RF communication network for communication between the plurality of automated devices and the automation controller. The plurality of access points can be distributed on each floor of the MDUs. The automation controller can log all user instructions provided to each of the plurality of automated devices and receives and logs status messages from each of the plurality of automated devices. The automation controller can analyze the logged user instructions and status messages to detect events and triggers mitigating actions to be taken in response to the detected events.

In accordance with example embodiments of the present invention, a method for managing a plurality of automated devices operating within multi-dwelling units (MDUs) is provided. The method includes creating a building network infrastructure. The building network infrastructure includes an automation controller in communication with an automation network server, at least one automation access point, and a plurality of automated devices. The method also includes creating a plurality of user accounts including one of dwelling user accounts and building manager user accounts and associating each of the plurality of user accounts with a subset of the plurality of automated devices based on an association with one or more particular units of the MDUs. The method further includes partitioning the plurality of automated devices according to the associated subset of the plurality of automated devices for each of the plurality of user accounts and providing individual users remote access to particular subsets of the plurality of automated devices through an application configured to communicate with the automation controller via the automation network server.

In accordance with aspects of the present invention, the automation controller is further configured to periodically send a message on health of all the plurality of automated devices on the building network infrastructure to the network automation server in a cloud. The building network infrastructure can be a radio frequency (RF) network managed by the automation controller and the at least one automation access point. The automation controller can track a status of each of the plurality of smart devices on the building network infrastructure. The method can also include a Power over Ethernet (PoE) switch, wherein the PoE switch enables at least one of the plurality of automated devices, access points, and the automation controller to be powered by the PoE switch and wherein the at least one of the plurality of automated devices, access points, and the automation controller are reset by sending a command to the PoE switch to power down and then power up one or more of the plurality of automated devices. The automation controller can be configured to improve reliability of battery-operated devices of the plurality of automated devices by waking up the battery-operated devices at certain intervals and the automation controller is programmed to poll, through the at least one automation access point, to which of the battery operated devices is included at certain intervals.

In accordance with aspects of the present invention, the access to the particular subsets of the plurality of automated devices for the dwelling user accounts restricts users to access of their particular dwelling including automated devices associated with their respective dwelling user account. The access to the particular subsets of the plurality of automated devices for the building manager user accounts can enable users to access all of the plurality of automated devices within the MDUs associated with a particular building manager user account including automated devices within each unit of the MDUs. The method can further include partitioning the plurality of automated devices into the particular subsets of the plurality of automated devices based on dwelling users accounts associated with the plurality of automated devices. The method can further include logging, by the automation controller, of all user instructions provided to each of the plurality of automated devices, receiving and logging, by the automation controller, status messages from each of the plurality of automated devices, and analyzing, by the automation controller, the logged user instructions and status messages to detect events and triggers mitigating actions to be taken in response to the detected events.

### DETAILED DESCRIPTION

The present invention relates to a system and method for managing smart or automated devices within a multi-dwelling unit. In particular, the present invention relates to a system and method enabling individual tenants to control the automated devices within their respective units and for a building manager or administrator to access and control automated devices for all units within the multi-dwelling units. More specifically, for occupants of individual units within a multi-dwelling unit, the building manager/administrative user registers accounts, registers automated devices, and associates the accounts with specific rights for each such occupant/user to specific automated devices. Building managers/administrative users will have similar accounts that have access to specific rights for all of the automated devices associated with each of the individual user accounts within the multi-dwelling unit. Similarly, all of the automated devices within the multi-dwelling unit within common areas can be registered and can provide shared access to all users associated with one of the multi-dwelling units. At the building infrastructure level, based on the specific rights assigned to each user, access and control for the automated devices associated with the users are partitioned and controlled by an automation controller. For example, the automation controller will enable, allow, and/or deny user access to particular automated devices based on the established rights of the users for the partitioned devices managed by the automation controller or server in the cloud.

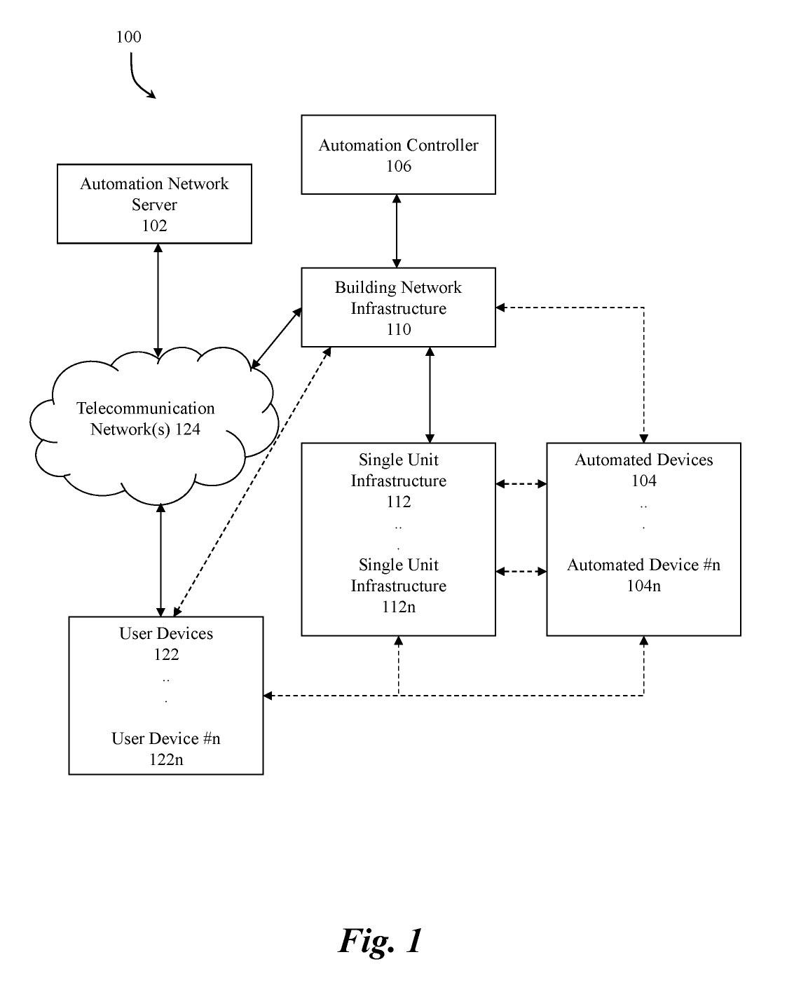

FIGS. 1 through 4, wherein like parts are designated by like reference numerals throughout, illustrate an example embodiment or embodiments of improved operation for a building management system for automated devices spread across multiple individual units in a multi-unit dwelling, according to the present invention. Although the present invention will be described with reference to the example embodiment or embodiments illustrated in the figures, it should be understood that many alternative forms can embody the present invention. One of skill in the art will additionally appreciate different ways to alter the parameters of the embodiment(s) disclosed, such as the size, shape, or type of elements or materials, in a manner still in keeping with the spirit and scope of the present invention.

FIG. 1 depicts an illustrative building automation management system 100 for implementing the steps in accordance with the aspects of the present invention. In particular, FIG. 1 depicts a building automation management system 100 including an automation network server/proxy server 102 configured to either establish and manage a list of available automated devices 104 and user rights and access to those automated devices 104 within a multi-dwelling unit or provide these functions to remote user devices through access to the automation controller 106 (e.g., via the server 102). In accordance with an example embodiment, the automation network server 102 is a combination of hardware and software configured to carry out aspects of the present invention. In particular, the automation network server 102 can include a computing system with specialized software and databases designed for providing a method for managing automated devices 104 associated with different users (e.g., owners/operators) within a plurality of units of a multi-unit dwelling and providing remote access to the automation controller 106. For example, the automation network server 102 can be software installed on a computing device, a web based application provided by a computing device which is accessible by computing devices (e.g., the user devices 122), a cloud based application accessible by computing devices, or the like. The combination of hardware and software that make up the automation network server 102 are specifically configured to provide a technical solution to a particular problem utilizing an unconventional combination of steps/operations to carry out aspects of the present invention. In particular, the automation network server 102 is designed to execute a unique combination of steps to provide a novel approach to managing a plurality of automated devices 104 located within individual units (associated with specific occupant users) of a multi-dwelling unit (e.g., apartment, condo, commercial space, etc.).

As would be appreciated by one skilled in the art, the automation network server 102 can include a single computing device, a collection of computing devices in a network computing system, a cloud computing infrastructure, or a combination thereof. Similarly, as would be appreciated by one of skill in the art, the automation network server 102 can include a storage system that can include any combination of computing devices configured to store and organize a collection of data. For example, the storage system can be a local storage device on the computing device, a remote database facility, or a cloud computing storage environment. The storage system can also include a database management system utilizing a given database model configured to interact with a user for analyzing the database data.

The automation network server 102 is configured to provide users remote access to automated devices 104 within their respective dwellings as well as handle the user and device registration processes to be shared with an automation controller 106 located within or remote to the multi-unit dwelling. In other words, the automation network server 102 can act as a proxy server providing remote access for user devices to the automation controller 106 or by providing functions of an automation controller. To act as a proxy server, the automation network server 102 can be configured for communication with an automation controller 106 and plurality of user devices 122 through over a telecommunication network(s) 124. In an example embodiment, the automation network server 102 can act as a centralized host, for the automation controller 106 and user devices 122, providing the functionality for managing automated devices 104 in a multi-dwelling unit in a partitioned manner, where the partition function is provided by the automation controller 106 and/or the automation network server 102. The automation controller 106 is configured to provide users local and/or remote access to automated devices 104 within their respective dwellings based on the location of the automation controller 106. If the automation controller 106 is located within the multi-unit dwelling, users will be provided access to their respective automated devices 104, even in the event that connection to the automation network server 102 cannot be established. In accordance with an example embodiment of the present invention, the automation controller 106 can be made up from a plurality of automation controllers 106 communicating over the building network (e.g., via Ethernet, Wi-Fi, etc.) with the automaton network access devices/proxy devices located throughout multi-unit dwelling (e.g., by wing, floor, unit, etc. of the building). More specifically, to have the best response times, the building network infrastructure 110 can include multiple automation access points or automation controllers provided throughout a multi-dwelling unit that are all connected to the automation controller 106 (e.g., though Ethernet, Wi-Fi, etc.). For example, the automation controller 106 can communicate through Z-Wave (by Sigma Designs) access points to establish a radio frequency Z-wave network in turn communicating with the automated devices 104 that can be utilized in accordance with the present invention. In this example, the Z-Wave devices are part of the building network infrastructure 110 and single unit infrastructure 112. Each automation access point can be configured to operate in parallel and will send and receive building network infrastructure 110 and single unit infrastructure 112 messages so the configuration can support high network traffic.

Additionally, the automation controller 106 can each be responsible for managing different sets of building automated devices 104 (e.g., locks, light switches, thermostats and sensors, cameras, a door sentry system, etc.). Other such automation controllers can include voice controllers that act on voice commands or provide voice responses or music controllers that play selected music through connected speakers in selected locations in each unit. The automation controller 106 communicates with the automated devices 104, controls and monitors these devices, provides alerts on the concurrences of certain specified events or conditions, triggers actions or events on the occurrences of certain specified events or conditions, etc., all of this able to be programmed by the building manager/administrative user locally or remotely through the automation network server 102

The plurality of user devices 122 can include any combination of computing devices, as described with respect to the automation network server 102 computing device. For example, the plurality of user devices 122 can include any combination of servers, personal computers, laptops, tablets, smartphones, etc. In accordance with an example embodiment of the present invention, the computing devices 122 are configured to establish a connection and communicate over telecommunication network(s) 124 to carry out aspects of the present invention. For example, the user devices 122 can utilize the telecommunication network(s) 124 to communicate with the automation network server 102 and specific automated devices 104 (as permitted). As would be appreciated by one skilled in the art, the telecommunication network(s) 124 can include any combination of known networks. For example, the telecommunication network(s) 124 may be combination of a mobile network, WAN, LAN, or other type of network. The telecommunication network(s) 124 can be used to exchange data between the computing devices 102, 122, exchange data, and/or to collect data from additional sources.

Continuing with FIG. 1, the building automation management system 100 can include or otherwise be in communication with and/or communicate over (e.g., through the automation network server 102) hardware and software found within the multi-dwelling unit. In particular, the building automation management system 100 includes a building network infrastructure 110 and single unit infrastructure 112. In accordance with an example embodiment of the present invention, the building network infrastructure 110 can include the following connected to a Power over Ethernet (PoE) switch: the automation controller 106, automation access points, a video storage server, video cameras, Wi-Fi access points, automated devices 104, sensor devices, a door entry system at the building entrance, a meter server of water meters, a router, a UPS, and a cable, fiber, cellular network, or DSL modem. With the automation controller 106 in the building as part of the building network infrastructure 110, rather than being located remotely (e.g., in the cloud), the building automation management system 100 will continue to operate even if the internet connection to the outside goes down. As would be appreciated by one skilled in the art, the automation controller 106 could also be located remotely from the multi-dwelling unit without departing from the scope of the present invention. Additionally, the hardware elements of the building network infrastructure 110 can include any combination of software and hardware that enables communication, data acquisition, etc. within an automated environment.

In accordance with an example embodiment of the present invention, similar to the building network infrastructure 110, the single unit infrastructure 112 can include modem(s), router(s), network switch, storage servers, and automated devices 104/sensors. As would be appreciated by one skilled in the art, the hardware elements of the single unit infrastructure 112 can include any combination of software and hardware that enables communication, data acquisition, etc. within an automated environment for a single dwelling unit (e.g., apartment, condo, office space, etc.). Typically, the devices in the single unit infrastructure 112 are personal devices under ownership and control of the user occupying the individual dwelling in which the devices reside and/or are under ownership and/or control of the building owner (e.g., the building units are rental units). Each unit within the multi-unit dwelling includes its own single unit infrastructure 112 unique associated with a dwelling user(s) such that a multi-unit dwelling will have an identifiable collection of single unit infrastructures 112 for multiple dwelling users. As would be appreciated by one skilled in the art, the automated devices 104 discussed herein can include any smart enabled automated devices 104 known in the art. For example, automated devices 104 include smart speakers, smart thermostats, door and window locks, smoke/CO2 sensors, light controls, smart home hubs, etc.

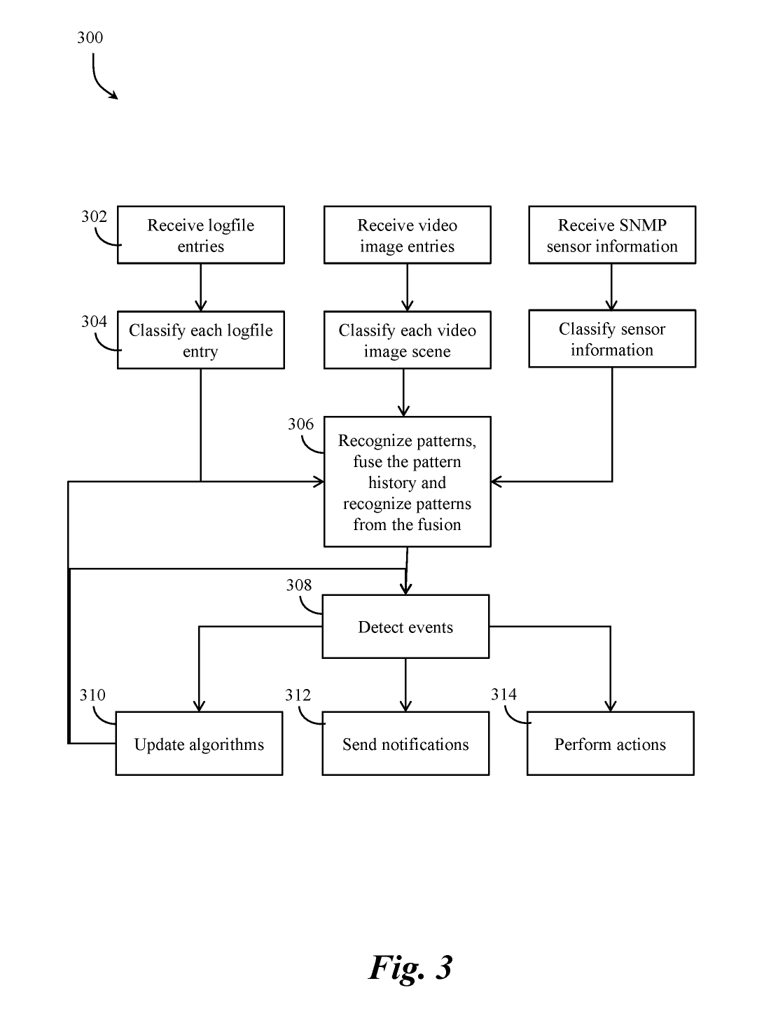

The configuration of the building network infrastructure 110 and the single unit infrastructure 112 provides reliability of the overall network within the building as a closed network for the automation controller 106, automation access points, a server storing video streams from video cameras, video cameras, Wi-Fi access points, a door entry system at the building entrance, a meter server of water meters, etc. Each of the devices within the MDU building can be monitored through network monitoring software implemented by the automation controller 106 and automation network server 102. For example, the monitoring can be performed utilizing a network management protocol (SNMP) that is able to determine whether all the devices on the building network infrastructure 110 are operating correctly (as discussed with respect to FIG. 3). For example, the automation controller 106 can be configured to periodically ping each of the devices within the building network infrastructure 110 to provide periodic health checks. If a device is not operating correctly, then it is possible to program the monitoring software to send an email notification, text, or other alert to an administrator or other user or perform an automated power-cycle of the device (e.g., when the device is powered from a power distribution unit (PDU) or plug bar that is also on the network).

In accordance with an example embodiment of the present invention, automated devices 104 that are battery-operated can be configured to wake-up in response to receiving a ping request and transmit health information or other status information and then return to sleep to conserver power. Reliability can be improved when the automated devices 104 are programmed to wake up at certain intervals and the automation controller 106 is programmed to poll (through the automation access point to which the battery operated device is included) at certain intervals. Then, if a message is missed, polling of the automated devices 104 will determine the correct state of the automated devices 104 (for example, if a door is open or closed).

In accordance with an example embodiment of the present invention, the automation controller 106 can track and log all user instructions provided through the server 102 and the automation controller 106 to their automated devices 104 and track and log all automated device 104 communications. For example, if a user utilized an application to change the temperature on their automated thermostat, the automation controller 106 will log the instruction and the device communications. Additionally, the automated devices 104 (and other devices) within the building network infrastructure 110 and/or single unit infrastructure 112 can periodically send status messages to the automation controller 106 or to the server 102. Thereafter, the automation controller 106 or server 102 can analyze and/or convey the status messages to the other user devices 122 (e.g., via email, text messages, or to an app running on the user devices). In response to the status messages received by the automation controller 106 (or automation network server 102), the automation controller 106 will log the status information for each automated device 104. With the logged data (e.g., instructions, status messages, etc.) the automation controller 106 can utilize monitoring software to analyze the logged data to determine whether there is a problem with a device (or a network problem) in the absence of messages from a particular device(s). In particular, the automation controller 106 (or automation network server 102) can be programmed to monitor, detect, and perform mitigating actions based on the patterns derived from the status messages, as discussed in greater detail with respect to FIG. 3. For example, based on programmable patterns/rule identification, the automation controller 106 can identify that a temperature has not increased at an automated thermostat even through instructions were communicated to increase the temperature several hours ago. As would be appreciated by one skilled in the art, patterns can be recognized at the automated device 104 level; at the unit level (e.g., all automated devices 104 within a unit), and/or at the multi-unit dwelling level (e.g., all automated devices 104 within a multi-unit dwelling). Additionally, the automation controller 106 can perform all the analyses and/or share the analysis with the server 102 (e.g., for crowd sourced data analysis).

Based on the preferences defined at the automation controller 106, mitigating actions can be initiated to handle identified issues. For example, the mitigating actions can include sending a notification to the user responsible for the problematic device indicating the issue. The message can also include suggestions such as power cycling the device or contacting the Internet service provider (ISP) if the ISP should be contacted to fix a possible plant issue. In addition to tracking the status messages of the automated devices 104 throughout the multi-dwelling unit (e.g., within the building network infrastructure 110 and the single unit infrastructure 112), the automation controller 106 can periodically send a message on the health of all the devices. In accordance with an example embodiment of the present invention, the building network infrastructure 110 can be configured to provide mitigating actions. For example, the multi-dwelling unit can include all Ethernet devices connected to a switch. By using a Power over Ethernet (PoE) switch, the devices powered by the switch can be easily reset by sending a command to the switch to power down and then power up any such device. For devices that are not PoE enabled, a PoE splitter can be used to provide power to these devise to enable these devices to be also power-cycled through the switch.

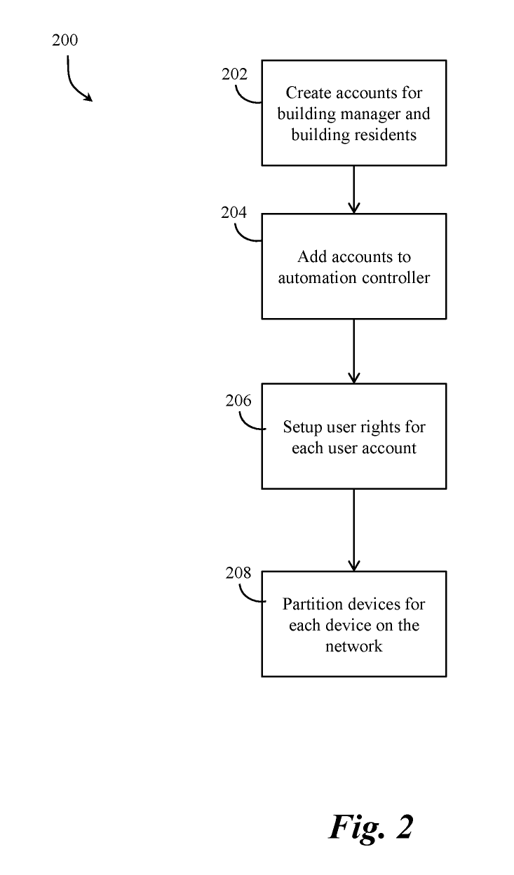

Users of the building automation management system 100 have access to monitor and control the automated devices 104 through their user devices 122 (e.g., smartphones, tablets, etc.) communicating through their cellular network (or the building Wi-Fi Network) to the server 102 (e.g., in the cloud) which then communicates to the automation controller 106 in their building or communicate directly with the automation controller 106 when the user devices 122 are within a communicative proximity of the local building network (e.g., building network infrastructure 110 and single unit infrastructure 112) to which the automation controller 106 is connected. Although the automation controller 106 is configured to communicate and monitor all automated devices 104 within a multi-unit dwelling, the users will only be able to access their permitted subset of automated devices 104 (e.g., due to the partitioning, discussed with respect to FIG. 2). Additionally or alternatively, tablets can be provided to each unit, which can use the building-wide Wi-Fi network to also access the automation controller 106 and then similarly, monitor and control the permitted subset of automated devices 104.

Because the automation controller 106 monitors all automated devices 104 within a multi-unit dwelling, the functionality of the building automation management system 100 is more than the functionality of each individual part. The functionality can benefit individual unit occupants as well as the unit occupants as a whole. For example, when a door to one unit is unlocked, the inside unit entrance light for that unit can be programmed to go on. If a door for outside access into the multi-unit dwelling is left open, an email or text message can be sent to all residents requesting that the door be closed. If water overflow is detected in a unit, then the water can be shut off to that unit through the automation controller 106 without relying on an individual to shut off the water themselves (manually or automated), which can prevent damage to adjacent units. If unauthorized entry to the building is detected in one unit, email or text alerts can be sent, a siren can be turned on, and lights can flash on and off or go on to notify occupants of units besides the one unit in which the automated device 104 resides. All the functionality can be monitored and controlled from anywhere in the world and actions to benefit all occupants can be triggered without action being taken by the owner of the automated device 104. This extends beyond the functionality provided by individual automated devices 104 which, if in isolation without benefit of the building automation management system 100 could only make an issue visible to a single user.

FIGS. 2 and 3 show illustrative flow charts depicting implementation of the system 100 in accordance with aspects of the present invention. Specifically, FIG. 2 depicts a flow chart showing the creation of user accounts and partitioning of automated devices 104 for enabling the functionality of the present invention. In particular, FIG. 2 depicts the process 200 for setting up, allocating rights, and partitioning devices for utilization by users within the system 100. At step 202, the system 100 creates user accounts for a building manager and for dwelling users residing within the multi-unit dwelling managed by the building manager. The dwelling user accounts and the building manager user accounts will be stored and managed by the automation controller 106 or the automation network server 102. As would be appreciated by one skilled in the art, the user account setup can include setting up a user name and password, setting user preferences, adding automated device 104 to their profile, etc. Additionally, either the building manager/administrative user has access to all automated devices or step 202 can include the dwelling users to provide certain permissions to the building manager account. For example, permission to access status information of their registered automated devices 104 and control those automated devices 104 in a case of emergency (e.g., shut off water, flash lights in an emergency, play tones in an emergency, etc.).

At step 204 the user accounts are added to the storage for the automation controller 106 within the building network infrastructure 110. In particular, the building manager/administrative user can set or the server 102 will contact/communicate with the automation controller 106 and update the user profiles within the automation controller 106 with the appropriate information (e.g., user controlled automated device 104). For example, the automation controller 106 can be updated with a list of dwelling users, a list of automation devices 104 associated with each of the dwelling users, building manager users, and permissions afforded the building manager users and/or dwelling users for access and/or control of the automated devices 104 associated with the dwelling users. As would be appreciated by one skilled in the art, data, access, and control of each automated devices 104 can be customized by each dwelling user according to their preferences.

At step 206 the automation controller 106 sets up the user rights for each user account. In particular, the automation controller 106 will distinguish and create rights for which automated devices 104 within the multi-unit dwelling that each user account has permission to access and/or control. Resident users of particular units within the multi-dwelling unit will be restricted to accessing their own automated devices 104 and potentially any publically shared automated devices 104 within the multi-unit dwelling. For example, a user account associated with Unit A will only be provided with permissions to access the automated devices 104 located within Unit A. The assigned permissions can be provided to the automation controller 106. Building manager and/or administrative users will be provided access to all of the automated devices 104 (or the automated devices 104 permitted by the dwelling users) within the multi-unit dwelling, including all of the automated devices 104 within each of the individual dwelling units. The permissions for the different users and user types are implemented by partitioning the automated devices 104 as performed in step 208.

At step 208 the server 102 takes inventory of each automated device located within the multi-unit dwelling are partitioned according to the user access defined in step 206. In particular, the automation controller 106 includes a list of all the automated devices 104 within the multi-dwelling unit and a list of dwelling users associated with each of the automated devices 104 and based on those associations, the automation controller 106 partitions the automated devices 104 into groups, each group associated with a specific dwelling user. This enables the automation controller 106 to track and monitor all of the automated devices 104 within the multi-unit dwelling while being able to restrict access to those devices by other users (e.g., any user other than the partitioned associated user or the building manager).

FIG. 3 depicts a process 300 for monitoring each of the automated devices 104 by the automation controller 106 (or server 102). In particular, process 300 depicts how the automation controller 106 monitors all of the automated devices 104 throughout the multi-unit dwelling and identifies programmed events matching predefined criteria or learned criteria matching the status information for the automated devices 104.

At step 302 the automation controller 106 receives the status messages and logs user instructions transmitted to the automated devices 104. In the exemplary process 300 of FIG. 3, that information includes aggregating and storing logfiles, video image entries, and simple network management protocol (SNMP) messages (e.g., health status information) for all the automated devices 104 in the multi-unit dwelling.

At step 304 the automation controller 106 classifies the received logfiles, the video scenes, and the SNMP sensor information. In particular, the automation controller 106 analyzes the data received from each of the automated devices 104. The analysis is performed at the automated device 104 level, individual unit level (including all automated devices 104 within a unit according to the partitions), and a multi-unit dwelling level (including all automated devices 104 within the multi-unit dwelling).

At step 306 the automation controller 106 recognizes patterns in the classified data, fuses the patterns with historical pattern data, and performs recognition on the fused patterns. In particular, the automation controller 106 includes pre-programmed pattern recognition algorithms or learned algorithms that are configured to identify particular events that may be derived from particular combinations of information received from automated devices 104. For example, if the pre-programmed pattern recognition has a rule for the number of door openings over a period of time (e.g., 5 door openings in 5 minutes), an alert will be triggered if the automated devise 104 (or subset thereof) report a number exceeding that defined threshold (e.g., 6 openings in 5 minutes). As would be appreciated by one skilled in the art, the pattern recognition can be performed utilizing any combination of machine learning algorithms and to identify any combination of identifiable patterns known in the art.

At step 308 the automation controller 106 detects any events that were identified in the pre-programmed patterns or learned pattern recognition algorithms. For example, the automation controller 106 detects an event that is defined by a pre-programmed rule.

At steps 310, 312, and 314 the automation controller 106 triggers mitigating action(s) based on the pre-programmed response associated with the detected event(s). As would be appreciated by one skilled in the art, all of the steps 310, 312, and 314 can occur simultaneously, consecutively, and/or selectively (e.g., one, two, or all three of the steps triggers) based on the type/circumstances of the detected event. In particular, at step 310, the machine learning algorithm is updated with the detected event(s). This will also trigger a loop that returns the process 300 to steps 306 and/or 308 for more accurate pattern recognition and machine training or learning. At step 312 notifications identifying the detected event(s) are transmitted to the appropriate user devices 122. The notifications can be transmitted to effected users which can include individual dwelling users, a subset of the dwelling users within an MDU, all of the dwelling users within an MDU, the building manager, or a combination thereof. At step 314 automated mitigating actions are performed by the automation controller 106 (e.g., remote power cycle, sounding a siren, shutting off water, etc.). Additionally, step 314 can include instructing the appropriate user mitigating action to take.

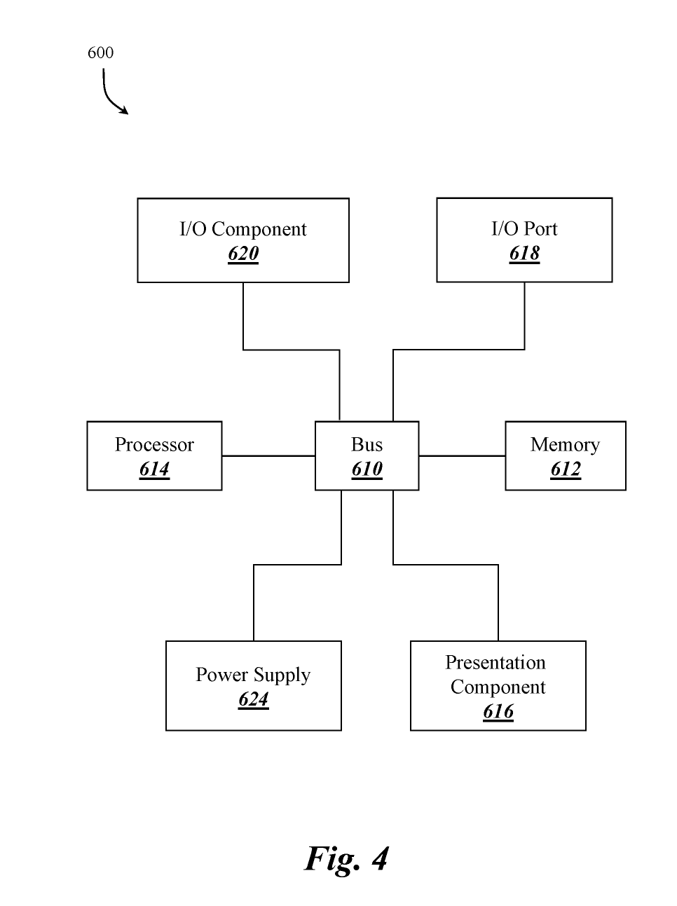

Any suitable computing device can be used to implement the computing devices 102, 122 and methods/functionality described herein and be converted to a specific system for performing the operations and features described herein through modification of hardware, software, and firmware, in a manner significantly more than mere execution of software on a generic computing device, as would be appreciated by those of skill in the art. One illustrative example of such a computing device 600 is depicted in FIG. 4. The computing device 600 is merely an illustrative example of a suitable computing environment and in no way limits the scope of the present invention. A “computing device,” as represented by FIG. 4, can include a “workstation,” a “server,” a “laptop,” a “desktop,” a “hand-held device,” a “mobile device,” a “tablet computer,” or other computing devices, as would be understood by those of skill in the art. Given that the computing device 600 is depicted for illustrative purposes, embodiments of the present invention may utilize any number of computing devices 600 in any number of different ways to implement a single embodiment of the present invention. Accordingly, embodiments of the present invention are not limited to a single computing device 600, as would be appreciated by one with skill in the art, nor are they limited to a single type of implementation or configuration of the example computing device 600.

The computing device 600 can include a bus 610 that can be coupled to one or more of the following illustrative components, directly or indirectly: a memory 612, one or more processors 614, one or more presentation components 616, input/output ports 618, input/output components 620, and a power supply 624. One of skill in the art will appreciate that the bus 610 can include one or more busses, such as an address bus, a data bus, or any combination thereof. One of skill in the art additionally will appreciate that, depending on the intended applications and uses of a particular embodiment, multiple of these components can be implemented by a single device. Similarly, in some instances, a single component can be implemented by multiple devices. As such, FIG. 4 is merely illustrative of an exemplary computing device that can be used to implement one or more embodiments of the present invention, and in no way limits the invention.

The computing device 600 can include or interact with a variety of computer-readable media. For example, computer-readable media can include Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 600.

The memory 612 can include computer-storage media in the form of volatile and/or nonvolatile memory. The memory 612 may be removable, non-removable, or any combination thereof. Exemplary hardware devices are devices such as hard drives, solid-state memory, optical-disc drives, and the like. The computing device 600 can include one or more processors that read data from components such as the memory 612, the various I/O components 616, etc. Presentation component(s) 616 present data indications to a user or other device. Exemplary presentation components include a display device, speaker, printing component, vibrating component, etc.

The I/O ports 618 can enable the computing device 600 to be logically coupled to other devices, such as I/O components 620. Some of the I/O components 620 can be built into the computing device 600. Examples of such I/O components 620 include a microphone, joystick, recording device, game pad, satellite dish, scanner, printer, wireless device, networking device, and the like.

As utilized herein, the terms “comprises” and “comprising” are intended to be construed as being inclusive, not exclusive. As utilized herein, the terms “exemplary”, “example”, and “illustrative”, are intended to mean “serving as an example, instance, or illustration” and should not be construed as indicating, or not indicating, a preferred or advantageous configuration relative to other configurations. As utilized herein, the terms “about”, “generally”, and “approximately” are intended to cover variations that may existing in the upper and lower limits of the ranges of subjective or objective values, such as variations in properties, parameters, sizes, and dimensions. In one non-limiting example, the terms “about”, “generally”, and “approximately” mean at, or plus 10 percent or less, or minus 10 percent or less. In one non-limiting example, the terms “about”, “generally”, and “approximately” mean sufficiently close to be deemed by one of skill in the art in the relevant field to be included. As utilized herein, the term “substantially” refers to the complete or nearly complete extend or degree of an action, characteristic, property, state, structure, item, or result, as would be appreciated by one of skill in the art. For example, an object that is “substantially” circular would mean that the object is either completely a circle to mathematically determinable limits, or nearly a circle as would be recognized or understood by one of skill in the art. The exact allowable degree of deviation from absolute completeness may in some instances depend on the specific context. However, in general, the nearness of completion will be so as to have the same overall result as if absolute and total completion were achieved or obtained. The use of “substantially” is equally applicable when utilized in a negative connotation to refer to the complete or near complete lack of an action, characteristic, property, state, structure, item, or result, as would be appreciated by one of skill in the art.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. Within this specification embodiments have been described in a way which enables a clear and concise specification to be written, but it is intended and will be appreciated that embodiments may be variously combined or separated without parting from the invention. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A system for managing a plurality of automated devices operating within multi-dwelling units (MDUs), the system comprising:
a building network infrastructure comprising;
an automation controller in communication with an automation network server and at least one automation access point; and
a plurality of automated devices each associated with one of a dwelling user account;
wherein individual dwelling users have access to a subset of the plurality of automated devices remotely through an application configured to communicate with the automation controller, the subset of the plurality of automated devices being associated with one or more particular unit MDUs.

2. The system of claim 1, wherein the automation controller is further configured to periodically send a message on health of all the plurality of automated devices on the building network infrastructure to the automation network server in a cloud.

3. The system of claim 1, wherein the building network infrastructure is a radio frequency (RF) network managed by the automation controller and the at least one automation access point.

4. The system of claim 1, wherein the automation controller tracks a status of each of the plurality of smart devices on the building network infrastructure.

5. The system of claim 1, further comprising a Power over Ethernet (PoE) switch, wherein the PoE switch enables at least one of the plurality of automated devices, access points, and the automation controller to be powered by the PoE switch and wherein the at least one of the plurality of automated devices, access points, and the automation controller are reset by sending a command to the PoE switch to power down and then power up one or more of the plurality of automated devices.

6. The system of claim 1, wherein the automation controller is configured to improve reliability of battery-operated devices of the plurality of automated devices by waking up the battery-operated devices at certain intervals and the automation controller is programmed to poll, through the at least one automation access point, to which of the battery operated devices is included at certain intervals.

7. The system of claim 1, wherein the individual dwelling users have remote access to a subset of the plurality of automated devices remotely through a server in communication with the automation controller.

8. The system of claim 1, wherein the at least one automation access point comprises a plurality of access points operating in parallel to establish a RF communication network for communication between the plurality of automated devices and the automation controller.

9. The system of claim 8, wherein the plurality of access points are distributed on each floor of the MDUs.

10. The system of claim 1, wherein the automation controller logs all user instructions provided to each of the plurality of automated devices and receives and logs status messages from each of the plurality of automated devices.

11. The system of claim 10, wherein the automation controller analyzes the logged user instructions and status messages to detect events and triggers mitigating actions to be taken in response to the detected events.

12. A method for managing a plurality of automated devices operating within multi-dwelling units (MDUs), the method comprising:
creating a building network infrastructure comprising;
an automation controller in communication with an automation network server;
at least one automation access point; and
a plurality of automated devices;
creating a plurality of user accounts including one of dwelling user accounts and building manager user accounts;
associating each of the plurality of user accounts with a subset of the plurality of automated devices based on an association with one or more particular units of the MDUs;
partitioning the plurality of automated devices according to the associated subset of the plurality of automated devices for each of the plurality of user accounts;
providing individual users remote access to particular subsets of the plurality of automated devices through an application configured to communicate with the automation controller via the automation network server.

13. The method of claim 12, wherein the automation controller is further configured to periodically send a message on health of all the plurality of automated devices on the building network infrastructure to the network automation server in a cloud.

14. The method of claim 12, wherein the building network infrastructure is a radio frequency (RF) network managed by the automation controller and the at least one automation access point.

15. The method of claim 12, wherein the automation controller tracks a status of each of the plurality of smart devices on the building network infrastructure.

16. The method of claim 12, further comprising a Power over Ethernet (PoE) switch, wherein the PoE switch enables at least one of the plurality of automated devices, access points, and the automation controller to be powered by the PoE switch and wherein the at least one of the plurality of automated devices, access points, and the automation controller are reset by sending a command to the PoE switch to power down and then power up one or more of the plurality of automated devices.

17. The method of claim 12, wherein the automation controller is configured to improve reliability of battery-operated devices of the plurality of automated devices by waking up the battery-operated devices at certain intervals and the automation controller is programmed to poll, through the at least one automation access point, to which of the battery operated devices is included at certain intervals.

18. The method of claim 12, wherein the access to the particular subsets of the plurality of automated devices for the dwelling user accounts restricts users to access of their particular dwelling including automated devices associated with their respective dwelling user account.

19. The method of claim 12, wherein the access to the particular subsets of the plurality of automated devices for the building manager user accounts enables users to access all of the plurality of automated devices within the MDUs associated with a particular building manager user account including automated devices within each unit of the MDUs.

20. The method of claim 12, further comprising partitioning the plurality of automated devices into the particular subsets of the plurality of automated devices based on dwelling users accounts associated with the plurality of automated devices.

21. The method of claim 12, further comprising:
logging, by the automation controller, of all user instructions provided to each of the plurality of automated devices;
receiving and logging, by the automation controller, status messages from each of the plurality of automated devices; and
analyzing, by the automation controller, the logged user instructions and status messages to detect events and triggers mitigating actions to be taken in response to the detected events.
